(19) United States
(12) Patent Application Publication
(10) Pub. No.: US 2025/0255424 A1
(43) Pub. Date: Aug. 14, 2025

(54) SMART OFFICE MAILBOX

(71) Applicant: KING FAISAL UNIVERSITY, AL-AHSA (SA)

(72) Inventors: JAWAHER MOHAMMED ALOMAIR, AL-AHSA (SA); MAZEN ALMULLA, AL-AHSA (SA); HAYA BASSAM ALHAQBANI, AL-AHSA (SA); KHAWLAH AHMED ALARFAJ, AL-AHSA (SA)

(21) Appl. No.: 18/439,354

(22) Filed: Feb. 12, 2024

(51) Int. Cl. A47G 29/124; A47G 29/122; H04M 1/72436

(52) U.S. Cl. CPC A47G 29/124; A47G 29/1225; H04M 1/72436; A47G 2029/1226; A47G 2029/1257; A47G 2200/08

(57) ABSTRACT

A smart office mailbox system includes a box for receiving documents. A touchscreen display is located at a front portion of the box. A slot is located at the front portion of the box for receiving documents. The touchscreen display receives input and opens an access panel covering the slot when documents are to be deposited into the box.

### BACKGROUND

### 1. Field

The present disclosure relates to communication systems, and particularly to a communication system that allows for leaving of messages and dropping off documents.

### 2. Description of the Related Art

Traditional mailboxes are a convenient way to drop off documents. This manual system has been used throughout time with great benefits. People have been able to leave documents at the mailbox of a recipient. In cases where there is a need for security, mailboxes are provided with locks.

### SUMMARY

Modern day professors have busy schedules and in many instances must provide a way for students to leave or access assignments, homework, take home quizzes and documents in a safe secure environment. Some of these items can be time sensitive or must not be seen by other students.

A Smart Office Mailbox (SOM) is an interactive communication tool. It can be used in a university environment for communications between students and professors. The body of a SOM is a box that receives documents through a slot located in the box. A display is also located at the front of the box. The slot and display portion of the box can be located outside the professor's office while the body of the box can extend into the professors office. The display can provide many functions such as 1) scheduling appointments, 2) leaving text or voice messages, 3) displaying messages or announcements, and 4) providing the faculty member's profile. An app can control the display through a mobile device such as a mobile phone, tablet, laptop or even a desktop computer.

A smart office mailbox system includes a box for receiving documents. A touchscreen display is located at a front portion of the box. A slot is located at the front portion of the box for receiving documents. The touchscreen display receives input and displays messages to communicate with users.

The smart office mailbox system further includes an access panel covering the slot. The touchscreen display opens the access panel when documents are to be deposited into the box.

The smart office mailbox system further includes an access door located on a wall of the box. When the access door is opened, it allows access to the interior of the box.

The smart office mailbox system further includes a personal identification number (PIN) code lock located on the access door.

The smart office mailbox system further includes an LED strip located on the front portion of the box indicating the availability of a custodian of the box, such as a professor or faculty member.

A smart office mailbox method includes: displaying a message on a touchscreen display located on a front portion of a box, the message prompting a user to select a function to perform; prompting the user to input an identification (ID) and password on the touchscreen display; and opening an access panel covering a slot located on the front portion of the box after receiving a valid ID and password.

The smart office mailbox further includes receiving a PIN code on a PIN code lock located on an access door located on a wall of the box. When a valid PIN code is received, the access door is unlocked thereby allowing access to the interior of the box.

The smart office mailbox method further includes lighting an LED strip located on the front portion of the box indicating the availability of a custodian of the box.

The smart office mailbox method further includes leaving a message on the touchscreen display from a mobile app, which can be located on a custodian's mobile phone.

These and other features of the present subject matter will become readily apparent upon further review of the following specification.

### BRIEF DESCRIPTION OF THE DRAWINGS

FIG. 1 is an illustration of an SOM located in a wall next to a door of an office.

FIGS. 2A, 3A and 4A are illustration of the SOM in a wall of an office.

FIGS. 2B, 3B and 4B are illustrations of the SOM next to a door of an office.

FIGS. 5A, 5B, 5C and 5D are screen shots of the interactive touch screen display of an SOM for student submissions.

FIGS. 6A and 6B are screen shots of an interactive touch screen display of an SOM when a student is scheduling an appointment with a professor.

FIGS. 7A, 7B and 7C are screen shots of an interactive touch screen display of an SOM when a student wants to leave a message for a professor.

FIG. 8 is a screen shot of a faculty member's profile.

FIG. 9 are screen shots of a mobile application on a professor's phone.

FIG. 10 are screen shots of a mobile application on a professor's phone allowing the faculty member to view Courses and Assignments Screens.

FIG. 11 are screen shots of a mobile application on a professor's phone allowing the faculty member to View, Accept and Reject appointments.

FIG. 12 are screen shots a mobile application on a professor's phone allowing the faculty member to leave announcements.

FIG. 13 are screen shots of a mobile application on a professor's phone allowing the faculty member to change the status of their availability.

Similar reference characters denote corresponding features consistently throughout the attached drawings.

### DETAILED DESCRIPTION OF THE PREFERRED EMBODIMENTS

A Smart Office Mailbox (SOM) is an interactive communication tool that serves students and faculty members who have offices on a university campus. The system includes two parts: an SOM that is located beside the faculty member's office door and a mobile application that is used by faculty members. The SOM is a box that further includes a front facing touchscreen, said touchscreen being accessible to students such that they can perform certain activities through this touchscreen that runs a software application that can be accessible to them via the internet or through a mobile application on their cell phone.

Meanwhile, the faculty can access the SOM using a mobile application that is connected to the mailbox and have remote control over the particular SOM assigned to their office, and in particular, the content of the touchscreen that is displayed to the students. The body of the SOM can be disposed inside the office while the screen and the linear slot through which student assignments, homework, take home quizzes, documents, and any material required to be turned into the faculty member is located outside of the wall to the office. This means that half of the SOM is inside the office wall while the remaining half is outside the office wall.

The interactive touch screen provides multiple functionalities for the students and faculty. A first feature is allowing the students to securely submit their assignments or course work using their student university ID and a password, selecting the assignment of the specific course, and pressing an “unlock” button to allow access to the slot for item submission to the faculty member. The faculty member can then collect the papers from the portion of the SOM that is inside the wall by using a PIN code lock and access door that is on one side of the portion of the SOM that is inside the wall. A second feature is scheduling appointments with the faculty member by picking a time and date slot in the student accessible faculty member schedule by means of the touchscreen. The third feature is being able to text or send voicemail to the faculty member. A fourth feature of the SOM is the capability for the faculty member to write announcements displayable on the touchscreen for the students. A fifth feature is presenting a faculty member's university profile on the touchscreen. The faculty member can also provide an indication of his/her availability on the SOM using the mobile application by displaying said indication which will be reflected directly on an LED strip attached to the SOM.

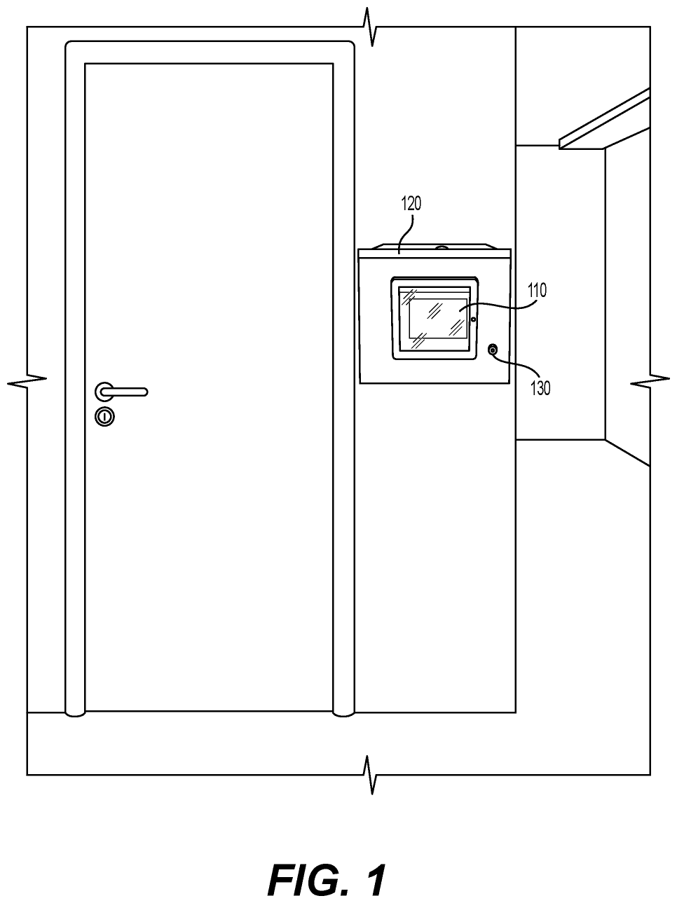

FIG. 1 is one non-limiting embodiment of an SOM 100 located in a wall next to a door of an office. SOM 100 includes an interactive touch screen display 110 located at a front portion of the SOM 100. The front portion of the SOM 100 also includes an LED strip 120 and a microphone 130. In a particular embodiment, the rear portion of the SOM 100 extends into the wall and to the interior of the office.

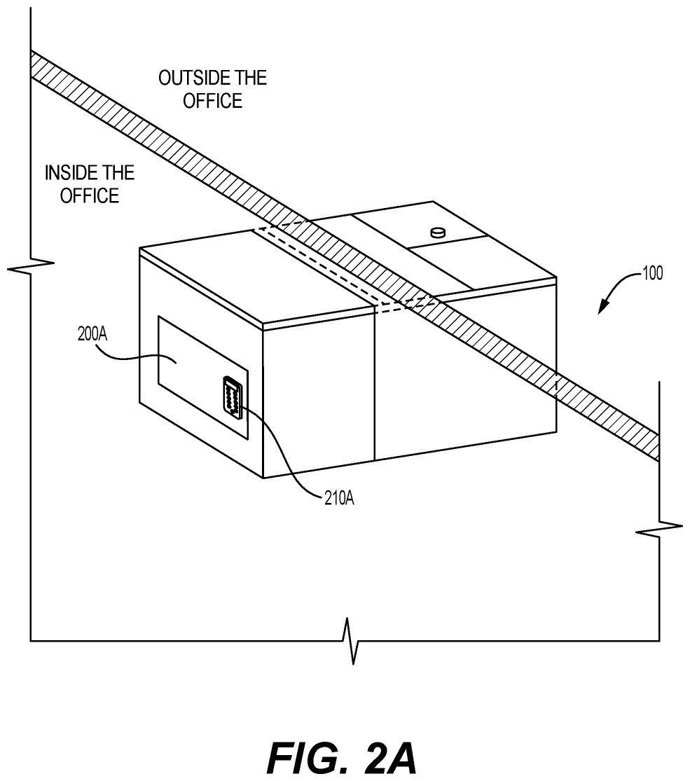

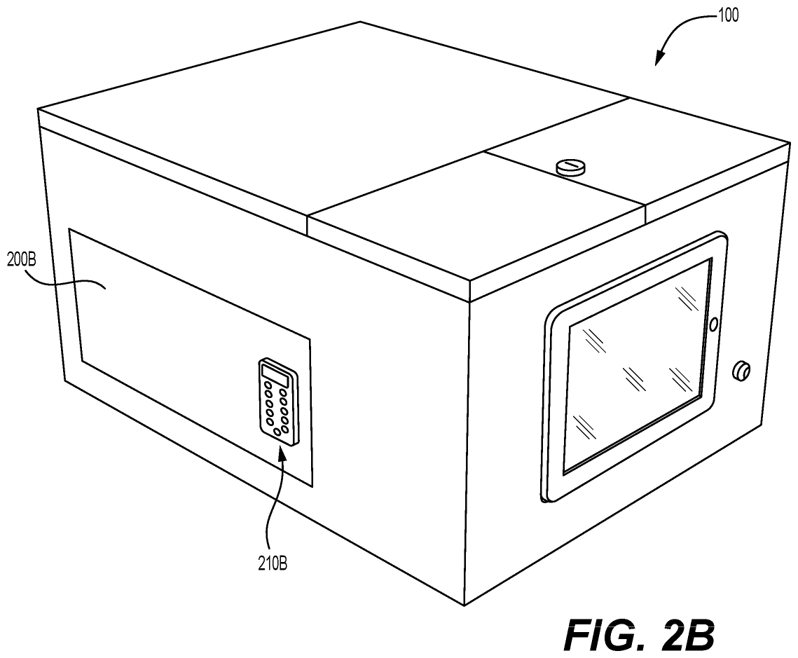

FIG. 2A is a top side perspective view of the SOM 100. SOM 100 includes an access door 200A located on a rear wall of the SOM 100 for collecting documents deposited into the SOM 100. A PIN code lock 210A secures the access door 200A.

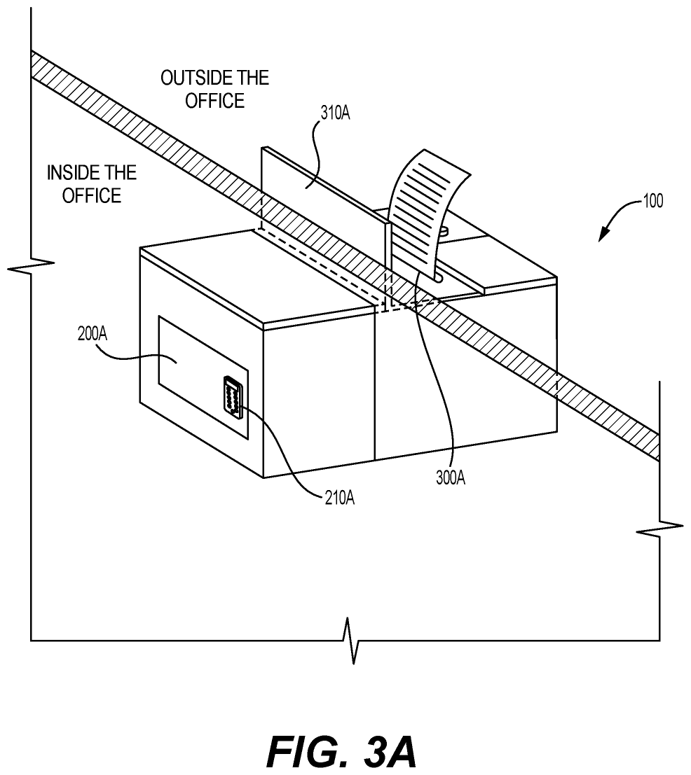

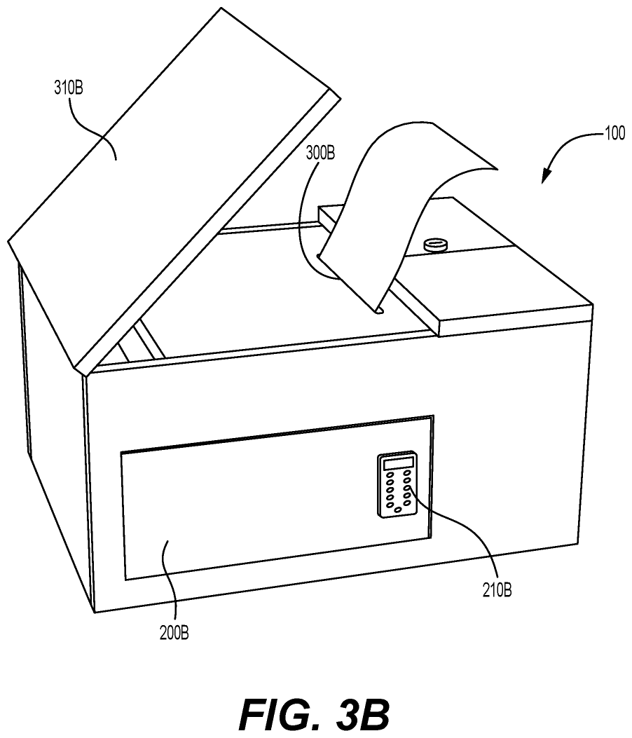

FIG. 3A is an illustration of the SOM 100 that includes a document submission slot 300A. An access panel 310A opens in this embodiment which exposes the document submission slot 300A. Documents can then be deposited into the SOM 100 through the slot 300A. The access panel 310A can be automated so that when a student ID and password are entered into the touch screen display 110, the access panel 310A automatically opens. In other embodiments, the access panel 310A may simply be unlocked, allowing a student to lift the access panel 310A to deposit documents into the SOM 100.

An access panel 310A may not be provided in some particular embodiments, allowing students to simply deposit documents into the SOM 100 through the document submission slot 300A. The access panel 310A and slot 300A can be very secure thereby not allowing users to remove documents once they are deposited into the box.

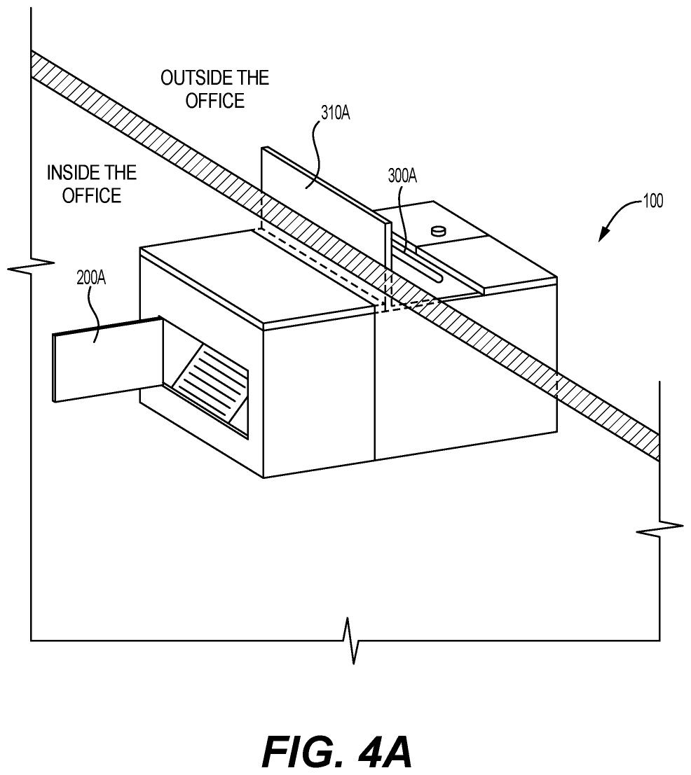

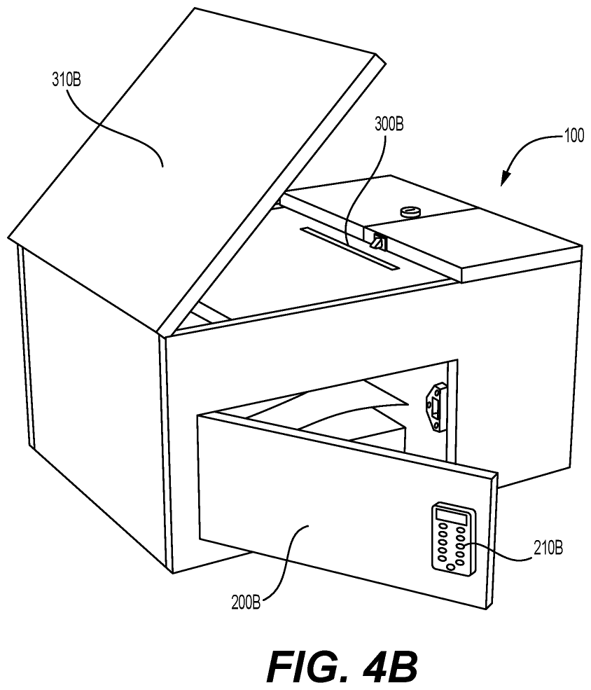

FIG. 4A is an illustration showing the documents deposited into the SOM 100 and the access door 200A opened allowing access to the documents. A professor can access the documents as illustrated by entering a pin code into the PIN code lock 210A and opening the access door 200A located on the rear wall of the SOM 100.

FIGS. 2B, 3B and 4B are illustrations of the SOM 100 located next to a door of an office. SOM 100 includes an access door 200B for collecting documents deposited into the SOM 100 and a PIN code lock 210B securing the access door 200B. The access door 200B is located on a side wall of the SOM 100.

FIG. 3B is an illustration of the SOM 100 that includes a document submission slot 300B. An access panel 310B opens in this embodiment which exposes the document submission slot 300B. Documents can then be deposited into the SOM 100 through the slot 300B. The access panel 310B can be automated so that when a student ID and password are entered into the touch screen display 110, the access panel 310B automatically opens. In other embodiments, the access panel 310B may simply be unlocked, allowing a student to lift the access panel 310B to deposit documents into the SOM 100.

FIG. 4B is an illustration showing the documents deposited into the SOM 100 and the access door 200B opened allowing access to the documents. A professor can access the documents as illustrated by entering a pin code into the PIN code lock 210B and opening the access door 200B located on a side wall of the SOM 100.

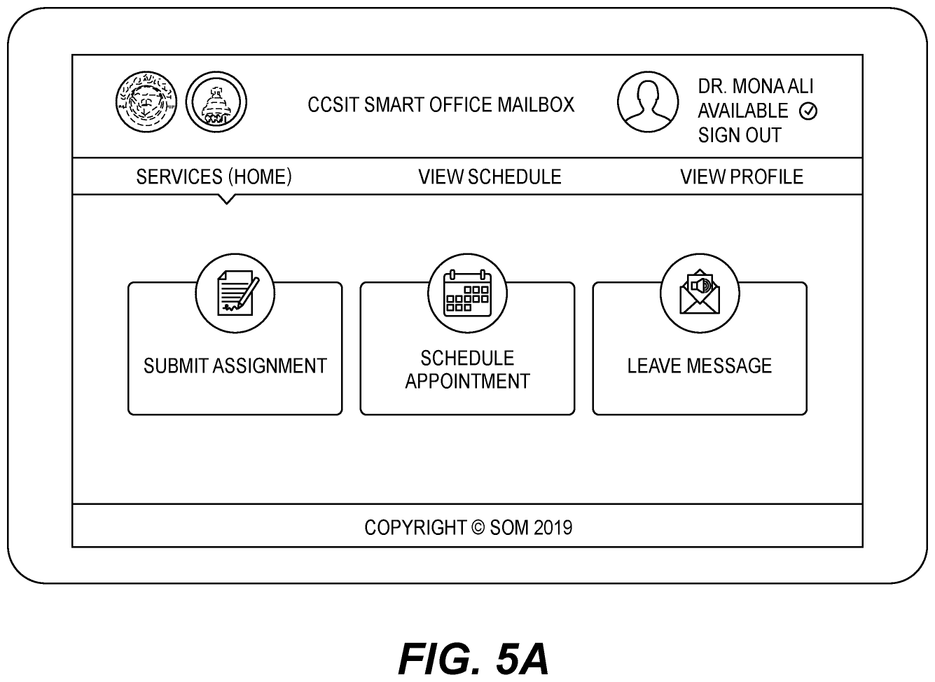

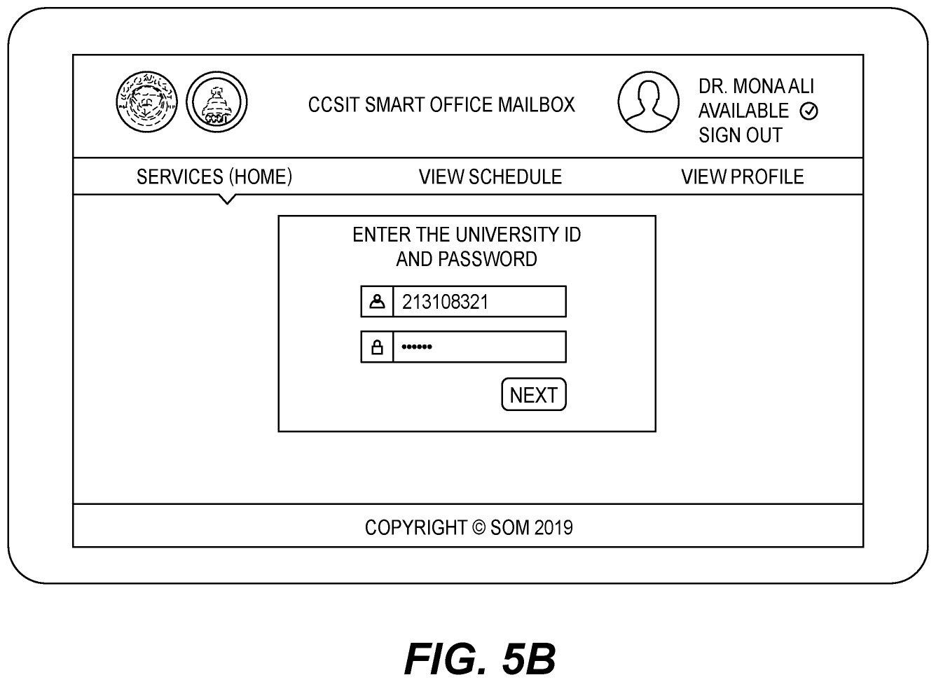

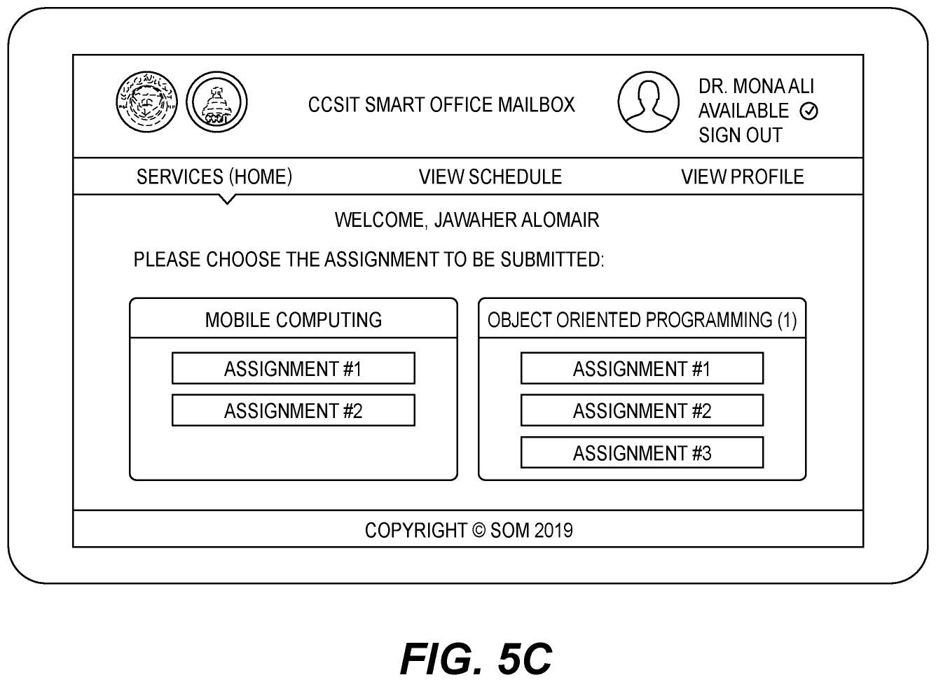

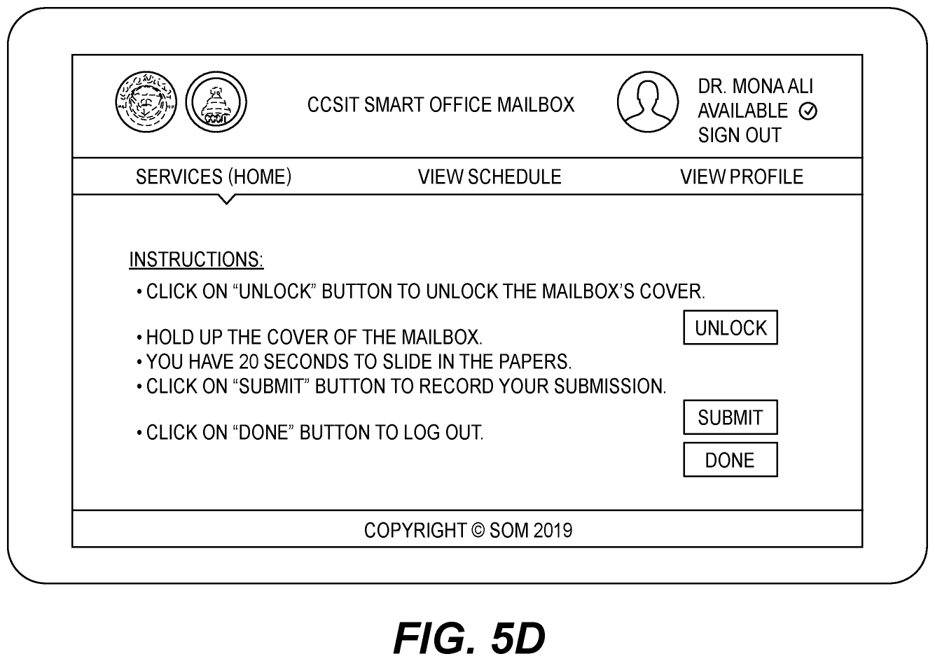

FIGS. 5A, 5B, 5C and 5D are non-limiting examples of screen shots of the interactive touch screen display 110 when a student is depositing documents into the SOM 100. FIG. 5A is an illustration of the initial screen giving students the option to submit assignments. A student can select the button “Submit Assignment” and is prompted to enter their University ID and Password as illustrated in FIG. 5B. Once a correct University ID and Password are entered, the student is able to choose which assignment is being submitted as illustrated in FIG. 5C. Instructions as illustrated in FIG. 5D are displayed to the student once an assignment is selected.

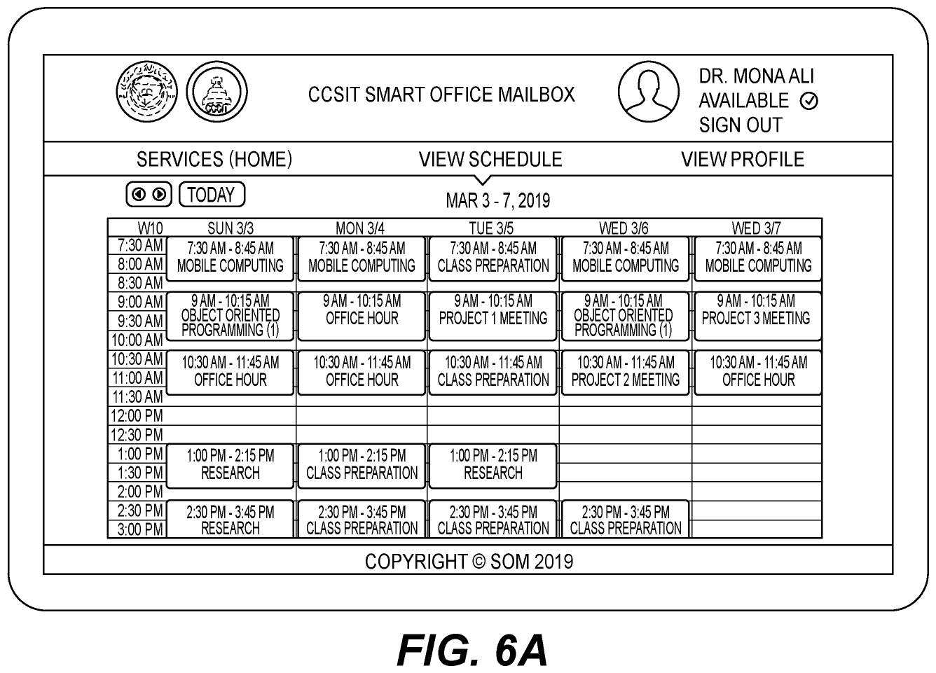

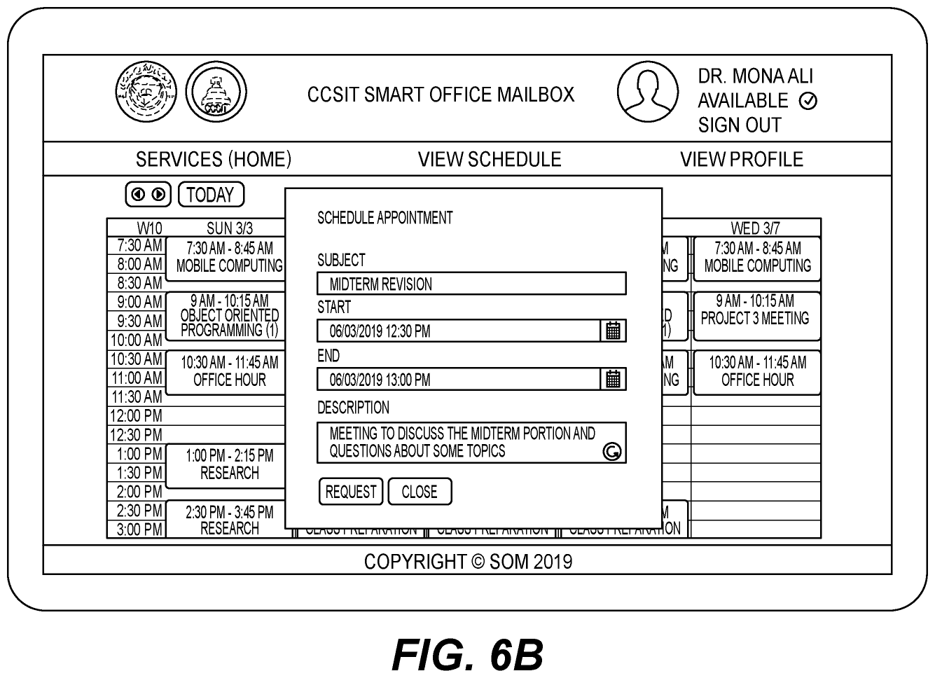

FIGS. 6A and 6B are non-limiting screen shots of the interactive touch screen display 110 when a student is scheduling an appointment with the professor. FIG. 6A shows the schedule of the professor indicating the times when the professor is available. Once the student selects a time slot a screen requesting further information, such as Subject, Start time, End time, and Description are requested. Once the student has entered the appropriate field, the student can press the Request button to schedule the appointment.

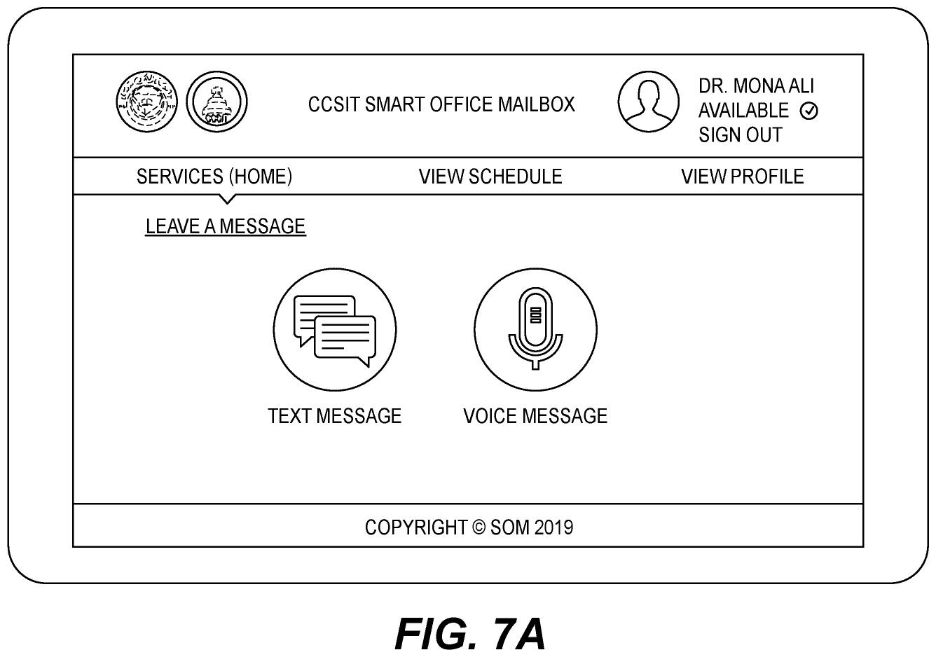

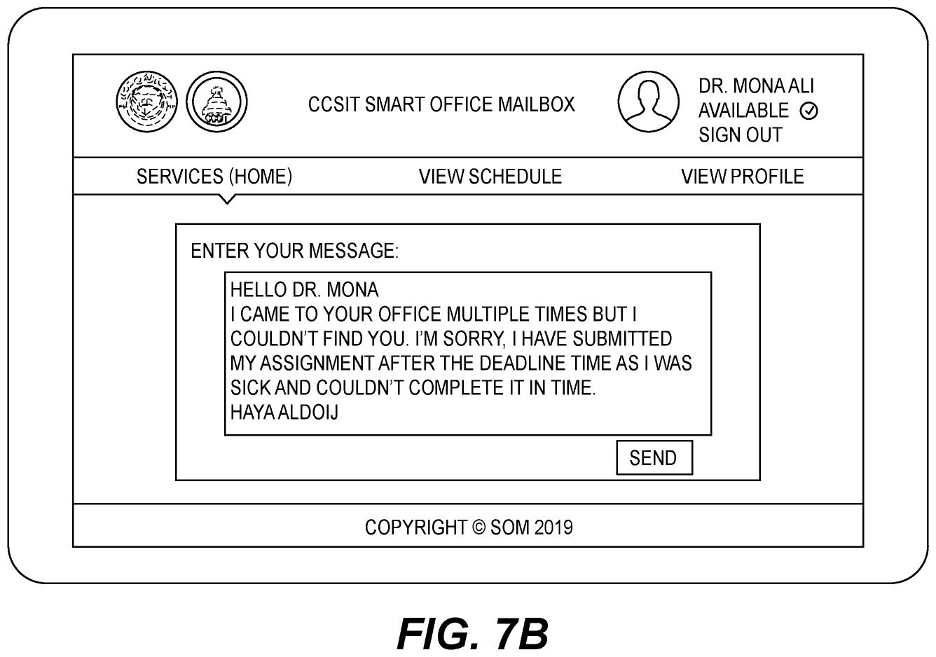

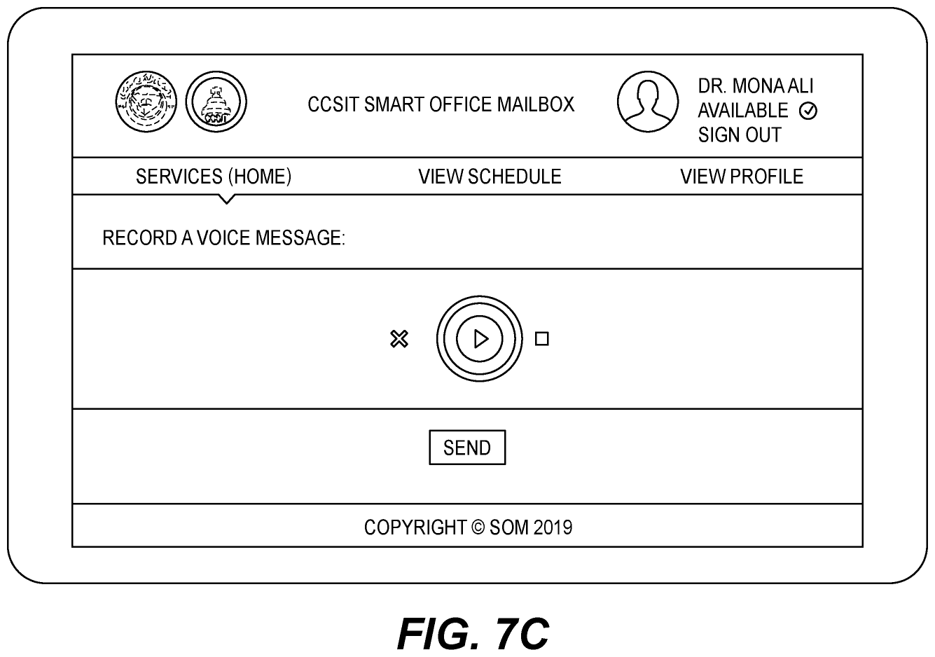

FIGS. 7A, 7B and 7C are non-limiting screen shots of the interactive touch screen display 110 when a student wants to leave a message for the professor. FIG. 7A is the initial screen giving the student the option to leave a text message. If a student chooses to leave a text message, a prompt will appear as illustrated in FIG. 7B. If a student chooses to leave a voice message, a prompt will appear as illustrated in FIG. 7C.

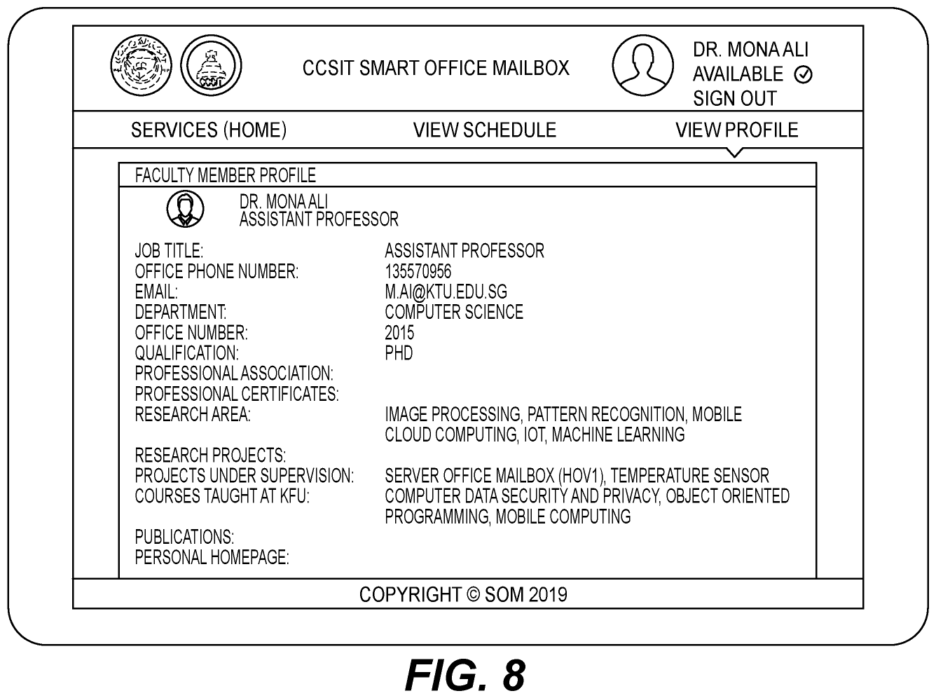

FIG. 8 is a non-limiting screen shot of the faculty member's profile.

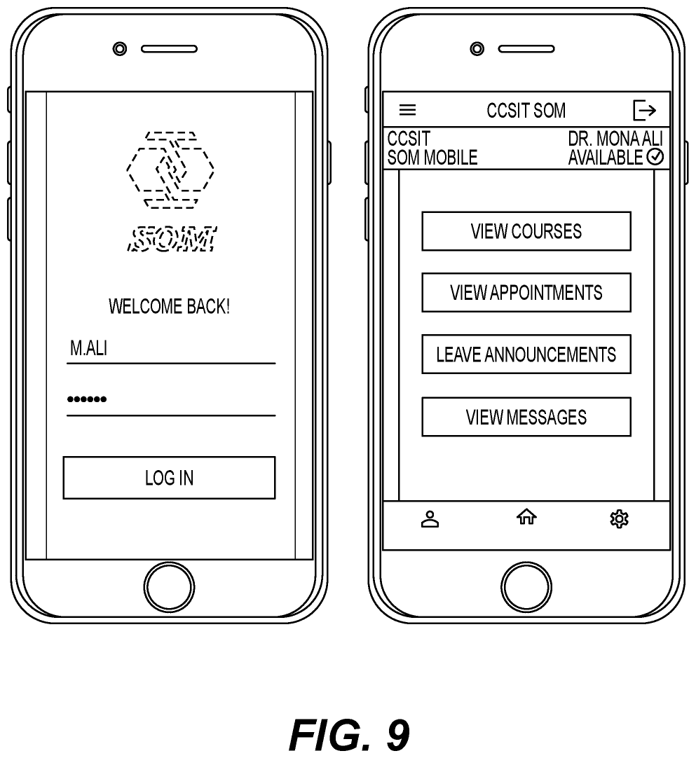

FIG. 9 are non-limiting screen shots of a mobile application on the professor's phone. It includes login information and options to View Courses, View Appointments, Leave Announcements and View Messages.

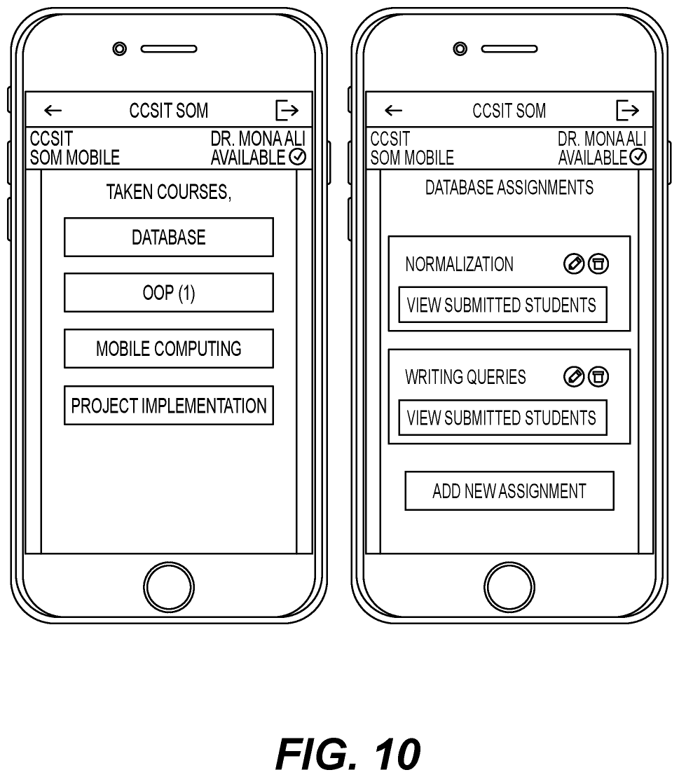

FIG. 10 are non-limiting screen shots of a mobile application on the professor's phone allowing the faculty member to view Courses and Assignments Screens.

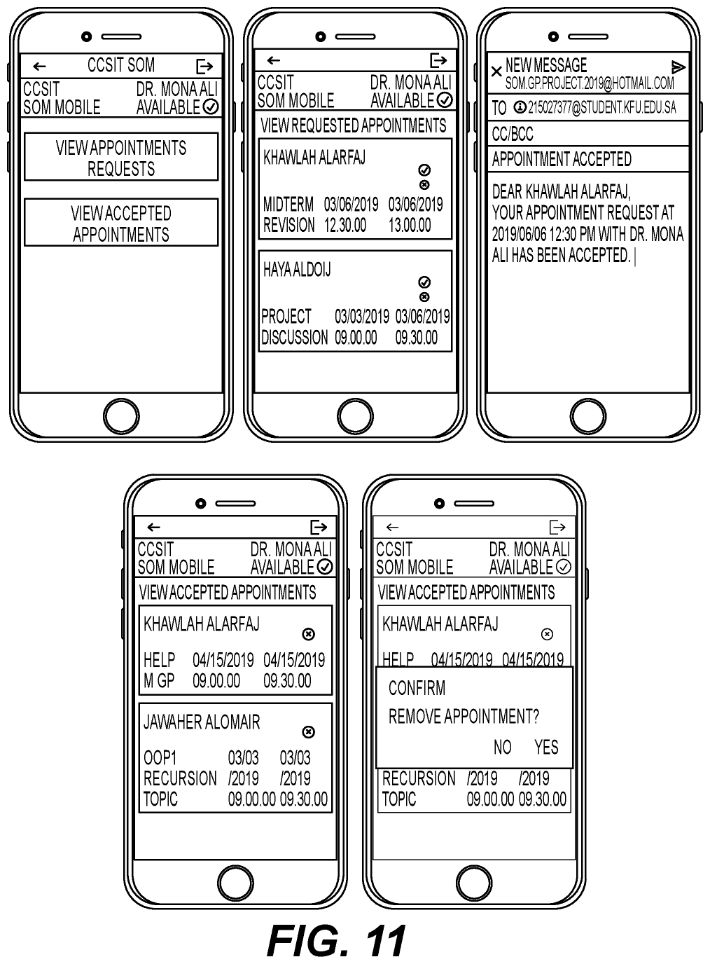

FIG. 11 are non-limiting screen shots of a mobile application on the professor's phone allowing the faculty member to View, Accept and Reject appointments.

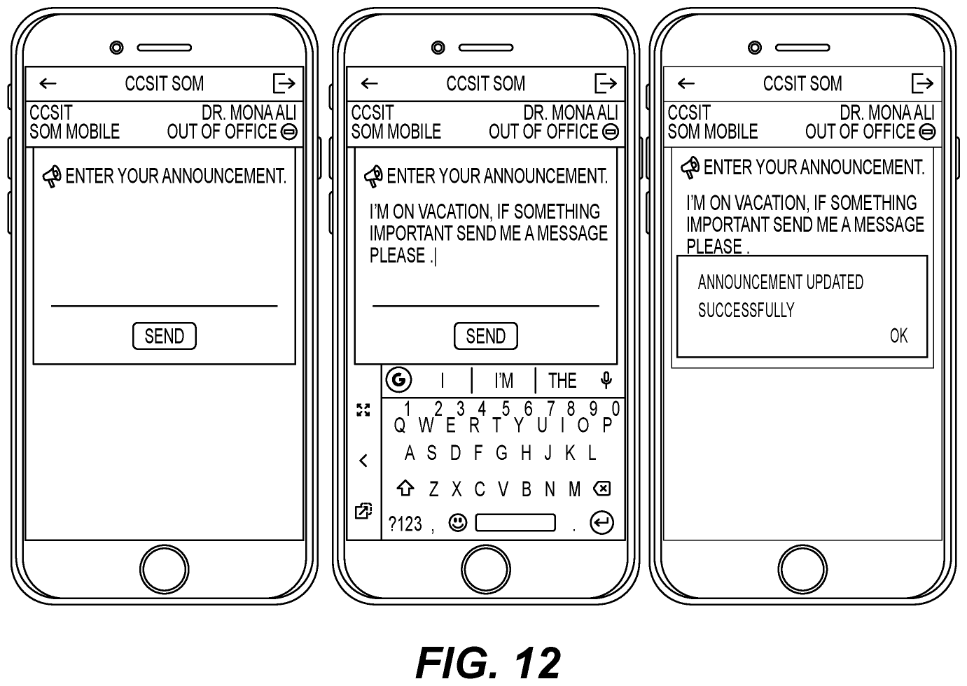

FIG. 12 are non-limiting screen shots a mobile application on the professor's phone allowing the faculty member to leave announcements.

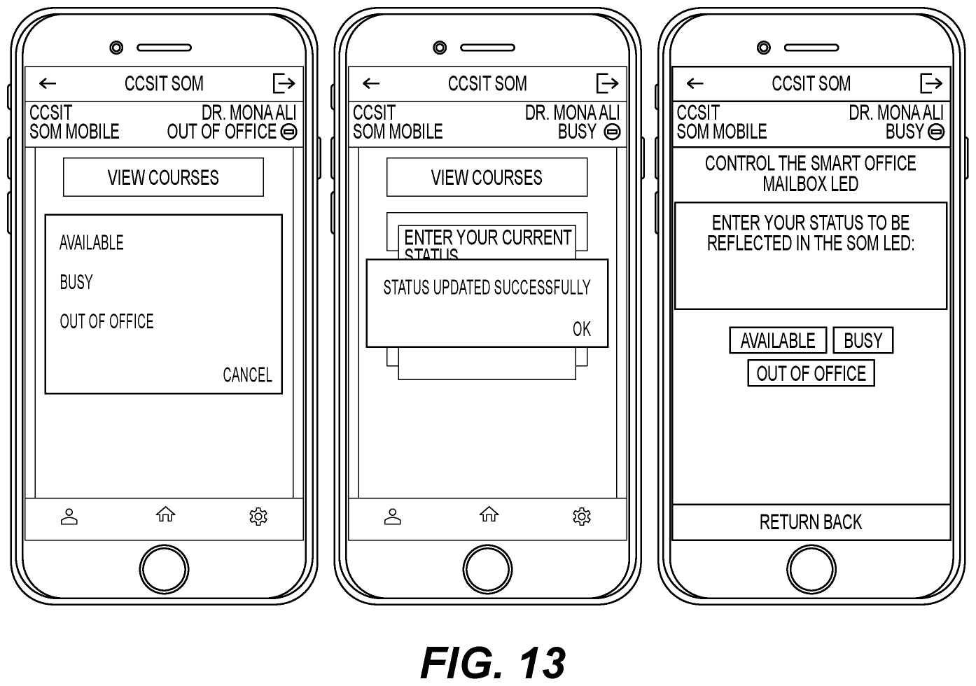

FIG. 13 are non-limiting screen shots of a mobile application on the professor's phone allowing the faculty member to change the status of their availability and control the LED Strip 120 to indicate the status of their availability.

The SOM 100 goes beyond the idea of receiving documents, it acts as a secretary for the office that is attached to. SOM 100 tells the students about whether the faculty member is currently inside the office or not through the LED Strip 120 attached to it, allows students to schedule appointments with that faculty member and leave messages.

It is to be understood that the present subject matter is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. A smart office mailbox system, comprising:
a box having a plurality of sidewalls defining an exterior of the box and an interior of the box for receiving documents therein;
a touchscreen display located at an exterior of a first sidewall of the plurality of sidewalls, said first sidewall being located at a front portion of the box;
a slot located on a second sidewall of the plurality of sidewalls at the front portion of the box for receiving the documents, said slot enabling access to the interior of the box from the exterior of the box, wherein the second sidewall is disposed adjacent to the first sidewall;
an access door located on a third sidewall of the plurality of sidewalls, wherein the access door enables access to the interior of the box from the exterior of the box, wherein the third sidewall is disposed adjacent to the second sidewall; and
an LED strip located on the front portion of the box indicating an availability of a faculty member associated with the box,
wherein the touchscreen display is configured to receive input and display messages to communicate with users.

2. The smart office mailbox system as recited in claim 1, further comprising an access panel covering the slot, wherein the touchscreen display opens the access panel when documents are to be deposited in the interior of the box.

3. (canceled)

4. The smart office mailbox system as recited in claim 1, further comprising a personal identification number (PIN) code lock located on the access door.

5. (canceled)

6. A smart office mailbox method, comprising:
displaying a message on a touchscreen display located on an exterior of a first sidewall of a box, said first sidewall being located at a front portion of the box, the message prompting a user to select a function to perform;
prompting the user to input an identification (ID) and password on the touchscreen display;
opening an access panel covering a slot after receiving a valid ID and password, said slot being located on a second sidewall of the box, said second sidewall being located at the front portion of the box, said slot enabling access to an interior of the box, wherein the second sidewall is disposed adjacent to the first sidewall;
depositing a first item in the interior of the box via the slot;
receiving a personal identification number (PIN) code on a PIN code lock located on an access door, said access door being disposed on a third sidewall of the box, different from the first and second sidewalls thereof, said access door enabling access to the interior of the box, wherein the third sidewall is disposed adjacent to the second sidewall,
wherein, when a valid PIN code is received, the access door is unlocked, providing access to the interior of the box; and
lighting an LED strip located on the front portion of the box indicating an availability of a faculty member associated with the box.

7-8. (canceled)

9. The smart office mailbox method as recited in claim 6, further comprising leaving a message on the touchscreen display from a mobile app located on a faculty member's mobile phone.

10. A smart office mailbox method, comprising:
displaying a message on a touchscreen display located on an exterior of a first sidewall of a box, said first sidewall being located at a front portion of the box, the message prompting a user to select a function to perform;
prompting the user to input an identification (ID) and password on the touchscreen display;
opening an access panel covering a slot after receiving a valid ID and password, said slot being located on a second sidewall of the box, said slot enabling access to an interior of the box, wherein the second sidewall is disposed adjacent to the first sidewall;
depositing a first item in the interior of the box via the slot;
receiving a personal identification number (PIN) code on a PIN code lock located on an access door, said access door being disposed on a third sidewall of the box, different from the first and second sidewalls thereof, said access door enabling access to the interior of the box, wherein the third sidewall is disposed adjacent to the second sidewall,
wherein, when a valid PIN code is received, the access door is unlocked, providing access to the interior of the box; and
leaving a message on the touchscreen display from a mobile app located on a faculty member's mobile phone.

11. The smart office mailbox method as recited in claim 10, further comprising receiving a personal identification number (PIN) code on a PIN code lock located on an access door located on a wall of the box, wherein, when a valid PIN code is received, the access door is unlocked giving access to the interior of the box.

12. The smart office mailbox system as recited in claim 1, wherein the third sidewall is located at a rear portion of the box.

13. The smart office mailbox system as recited in claim 1, wherein the third sidewall extends between the front portion of the box and a rear portion of the box.

14. The smart office mailbox method as recited in claim 6, wherein the third sidewall is located at a rear portion of the box.

15. The smart office mailbox method as recited in claim 6, wherein the third sidewall extends between the front portion of the box and a rear portion of the box.

16. The smart office mailbox method as recited in claim 10, wherein the third sidewall is located at a rear portion of the box.

17. The smart office mailbox method as recited in claim 10, wherein the third sidewall extends between the front portion of the box and a rear portion of the box.
